(19) United States
(12) Patent Application Publication
(10) Pub. No.: US 2008/0106353 A1
(43) Pub. Date: May 8, 2008

(54) HIGH-FREQUENCY SWITCH

(75) Inventors: Masatake Hangai, Tokyo (JP); Yukinobu Tarui, Tokyo (JP); Tamotsu Nishino, Tokyo (JP); Yoshitsugu Yamamoto, Tokyo (JP); Moriyasu Miyazaki, Tokyo (JP); Yoji Isota, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Tokyo (JP)

(21) Appl. No.: 11/748,852

(22) Filed: May 15, 2007

(30) Foreign Application Priority Data
Nov. 7, 2006 (JP) 2006-301556

(51) Int. Cl. H01P 1/15

(52) U.S. Cl. 333/103; 333/262

(57) ABSTRACT

The present invention provides a high-frequency switch including: a first switching element connected between a first input/output terminal and a second input/output terminal; a second switching element connected between the second input/output terminal and the first switching element; a high-frequency line provided between the first input/output terminal, the first switching element, and a third input/output terminal; and a third switching element connected between the third input/output terminal, the high-frequency line, and a ground. By connecting the first switching element, the second switching element, the high-frequency line, and the third switching element, because there exists no FET through which a large current flows when a state between the first input/output terminal and the third input/output terminal is set to a transmission state which requires high power handling capability, there is no need to use an FET having a large gate width, which is effective in reducing a loss of the switch.

### BACKGROUND OF THE INVENTION

1. Field of the Invention

The present invention relates to a high-frequency switch which can be provided with high power handling capability, with a low loss, and at low costs.

2. Description of the Related Art

As an example of a high-frequency switch, FIG. 10 shows a circuit diagram of a high-frequency switch disclosed in “Monolithic AlGaN/GaN HEMT SPDT switch” IEEE 12^{th} GaAs Symposium, pp. 83-86, 2004. The circuit is a double-pole single-throw switch in which field effect transistors (hereinafter, referred to as “FET”) connected in series with an output terminal COM are connected to two sets of an FET connected in parallel and an input terminal. In the circuit, by applying a voltage to control signal terminals V1 and V2, FETs Q1 to Q4 are caused to have a transmission property or an isolation property, whereby a path of a high-frequency signal is switched. Further, the circuit has characteristics in which power handling capability of the switch can be increased by an increase of each gate width of the FET Q1 and FET Q2 that are connected in series with each other and by an increase of each saturation current.

However, when the switch having high power handling capability is configured with the above-mentioned configuration, there arises a problem in that a transmission loss at an input of low power is increased as each gate width of the FETs connected in series with each other is increased in order to increase the power handling capability. For example, in FIG. 10, in a case where the high power handling capability is required so as to obtain a transmission state between an IN1 and the COM, it is necessary to increase the gate width of the FET Q1. However, the FET having a large gate width generally has a low isolation property. Accordingly, when the gate width of the FET Q1 is increased, a state between the IN1 and the COM is set to an isolation state, and a high-frequency signal from an IN2 leaks into the IN1 side when a state between the IN2 and the COM is set to the transmission state. As a result, the transmission loss between the IN2 and the COM is increased. The circuit has a symmetric configuration, so a similar problem also arises when the high power handling capability is required between the IN2 and the COM.

### SUMMARY OF THE INVENTION

According to the present invention, there is provided a high-frequency switch including:

a first input/output terminal;

a first switching element having one end connected to the first input/output terminal;

a second switching element having one end connected to the other end of the first switching element;

a first ground connected to the other end of the second switching element;

a second input/output terminal connected to the other end of the first switching element;

a high-frequency line having one end connected to the first input/output terminal;

a third switching element having one end connected to the other end of the high-frequency line;

a second ground connected to the other end of the third switching element; and

a third input/output terminal connected to the other end of the high-frequency line.

According to the present invention, the high-frequency line is provided in place of the FET between the first input/output terminal and the third input/output terminal. Accordingly, in a case where a state between the first input/output terminal and the third input/output terminal is set to a transmission state and high power handling capability is required, there exists no FET through which a large current flows. As a result, there is no need to provide an FET having a large gate width, which is effective in reducing a loss of the high-frequency switch.

### BRIEF DESCRIPTION OF THE DRAWINGS

In the accompanying drawings:

FIG. 1 is a circuit diagram showing a configuration of a high-frequency switch according to a first embodiment of the present invention;

FIG. 2 is an equivalent circuit diagram in a case where a first FET and a third FET shown in FIG. 1 are turned on and a second FET is turned off;

FIG. 3 is an equivalent circuit diagram in a case where the first FET and the third FET shown in FIG. 1 are turned off and the second FET is turned on;

FIG. 4 is perspective view showing an appearance of a configuration of the high-frequency switch of FIG. 1;

FIG. 5 is a circuit diagram showing a configuration of a high-frequency switch according to a second embodiment of the present invention;

FIG. 6 is an equivalent circuit diagram in a case where first FETs and third FETs shown in FIG. 5 are turned on and a second FET is turned off;

FIG. 7 is an equivalent circuit diagram in a case where the first FETs and the third FETs shown in FIG. 5 are turned off and the second FET is turned on;

FIG. 8 is a circuit diagram showing a configuration of a high-frequency switch according to a third embodiment of the present invention;

FIG. 9 is a circuit diagram showing a configuration of a high-frequency switch according to a fourth embodiment of the present invention; and

FIG. 10 is a circuit diagram of a conventional high-frequency switch.

### DESCRIPTION OF THE PREFERRED EMBODIMENTS

### First Embodiment

FIG. 1 is a circuit diagram showing a configuration of a high-frequency switch according to a first embodiment of the present invention. The high-frequency switch includes a first input/output terminal 1a, a second input/output terminal 1b, a third input/output terminal 1c, a first FET 2a, a second FET 2b, a third FET 2c, a high-frequency line 3, a first control signal terminal 4a, a second control signal terminal 4b, a first resistor 5a, a second resistor 5b, a third resistor 5c, a first ground 6a, and a second ground 6b.

In this embodiment, assuming that an electric length of the high-frequency line 3 is set to ¼ wavelength of an operating frequency, impedance of the first input/output terminal 1a is represented as Z1a, impedance of the third input/output terminal 1c is represented as Z1c, and impedance of the high-frequency line 3 is represented as Z3, the following formula is established.

Z1a=Z1c=Z3

Further, assuming that a saturation current which flows to the first FET 2a is represented as I2a, a saturation current which flows to the second FET 2b is represented as I2a, and a saturation current which flows to the third FET 2c is represented as I2c, the following formula is established.

I2c=I2a=I2b

First, an operation of the FET will be described.

The FET is turned on when a voltage equivalent to a drain voltage or a source voltage is applied to the control signal terminal, which can be assumed as an equivalent resistor at a high frequency (hereinafter, referred to as “on-resistance”). On the other hand, when a DC signal having a voltage level of equal to or lower than a pinch-off voltage is applied to the control signal terminal, the FET is turned off, which can be assumed as an equivalent capacitor at a high frequency (hereinafter, referred to as “off-capacitance”).

Next, an operation of the high-frequency switch according to the first embodiment of the present invention will be described.

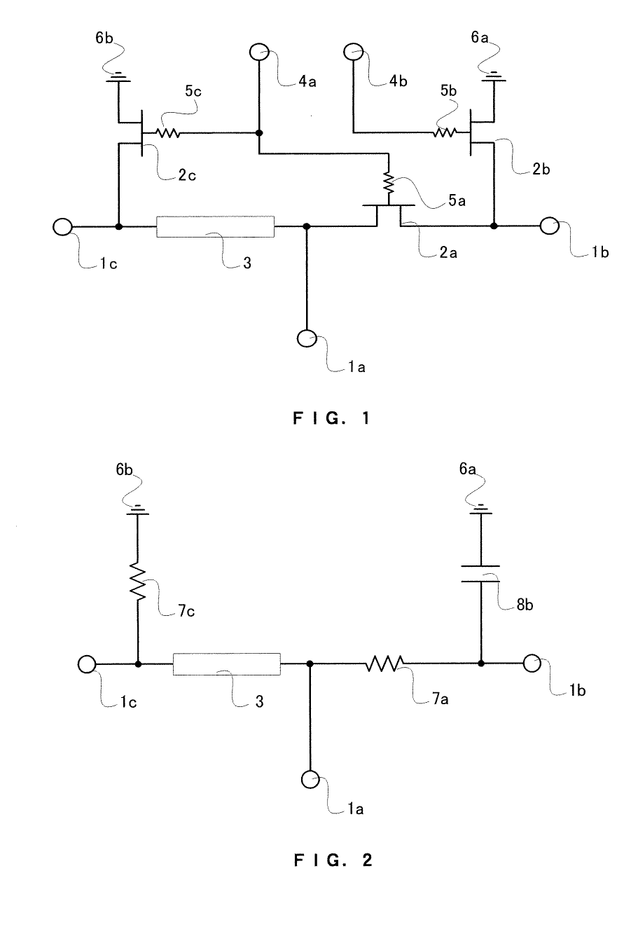

FIG. 2 shows an equivalent circuit in a case where the first FET 2a and the third FET 2c are turned on and the second FET 2b is turned off. In FIG. 2, reference symbol 7a denotes an on-resistance of the first FET 2a; 7c, an on-resistance of the third FET 2c; and 8b, an off-capacitance of the second FET 2b. In this case, a state between the first input/output terminal 1a and the second input/output terminal 1b becomes a transmission state, and a state between the first input/output terminal 1a and the third input/output terminal 1c becomes an isolation state.

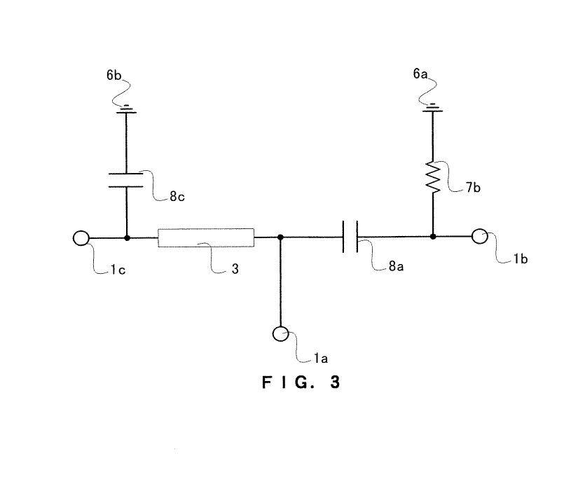

FIG. 3 shows an equivalent circuit in a case where the first FET 2a and the third FET 2c are turned off and the second FET 2b is turned on. In FIG. 3, reference symbol 8a denotes an off-capacitance of the first FET 2a; 8c, an off-capacitance of the third FET 2c; and 7b, an on-resistance of the second FET 2b. In this case, a state between the first input/output terminal 1a and the second input/output terminal 1b becomes the isolation state, and a state between the first input/output terminal 1a and the third input/output terminal 1c becomes the transmission state.

According to the first embodiment of the present invention, in a case where the high power handling capability is required when the state between the first input/output terminal 1a and the third input/output terminal 1c is set to the transmission state, there exists no FET through which a large current flows. As a result, there is no need to use an FET having a large gate width, which is effective in reducing a loss of the high-frequency switch.

Further, since the electric length of the high-frequency line 3 is set to ¼ wavelength of the operating frequency, when the state between the first input/output terminal 1a and the second input/output terminal 1b is set to the transmission state and the state between the first input/output terminal 1a and the third input/output terminal 1c is set to the isolation state, high-frequency signals which leak from the first input/output terminal 1a into the third input/output terminal 1c can be reduced, thereby improving the isolation property.

In addition, a relationship among the impedance Z1a of the first input/output terminal 1a, the impedance Z1c of the third input/output terminal 1c, and the impedance Z3 of the high-frequency line 3 is made to satisfy the following equation.

Z1a=Z1c=Z3

### Accordingly, an impedance matching property of the high-frequency circuit can be obtained, which is effective in increasing the power handling capability and reducing the loss.

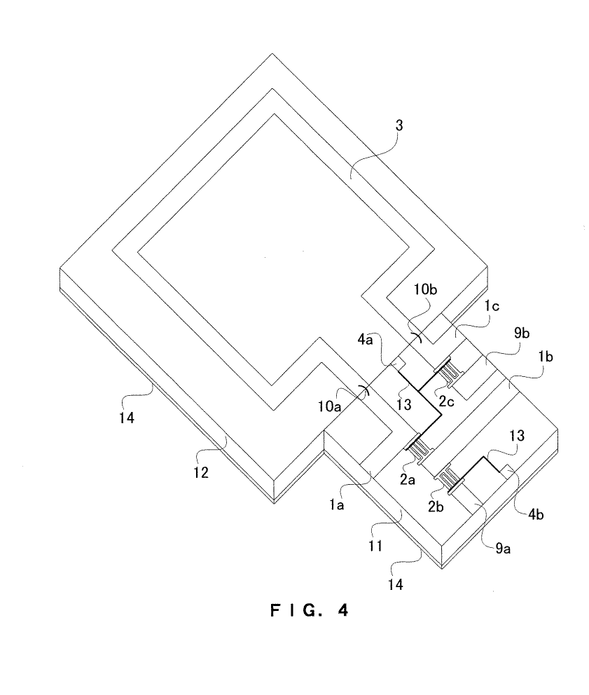

FIG. 4 is perspective view showing an appearance of a configuration in which the high-frequency switch shown in FIG. 1 is formed on a substrate. In FIG. 4, reference symbols 9a and 9b denote ground terminals; 10a and 10b, wires; 11, a semiconductor substrate; 12, a dielectric substrate; 13, a bias line; and 14, ground.

In FIG. 4, the high-frequency line 3 having a large occupation area is formed on the dielectric substrate 12 produced at a low cost, and components other than the high-frequency line 3 are formed on the semiconductor substrate 11. The high-frequency line 3 formed on the dielectric substrate 12, and the first input/output terminal 1a and the third input/output terminal 1c that are formed on the semiconductor substrate 11 are connected to each other via the wires 10a and 10b. With this configuration, an area for the semiconductor substrate 11 can be reduced, which is effective in reducing costs of the high-frequency switch.

In the above embodiment, the electric length of the high-frequency line is set to ¼ wavelength of the operating frequency, and the relationship among the impedance Z1a of the first input/output terminal 1a, the impedance Z1c of the third input/output terminal 1c, and the impedance Z3 of the high-frequency line 3 is made to satisfy the following equation.

Z1a=Z1c=Z3

However, even when the electric length of the high-frequency line is set to ¼ wavelength of the necessary frequency, and the relationship among the impedance Z1a of the first input/output terminal 1a, the impedance Z1c of the third input/output terminal 1c, and the impedance Z3 of the high-frequency line 3 is made to satisfy the following equation

Z1c=2×Z1a,

Z3=v2×Z1a,

the impedance matching property of the high-frequency circuit can be obtained, and the same effect can be achieved.

### Second Embodiment

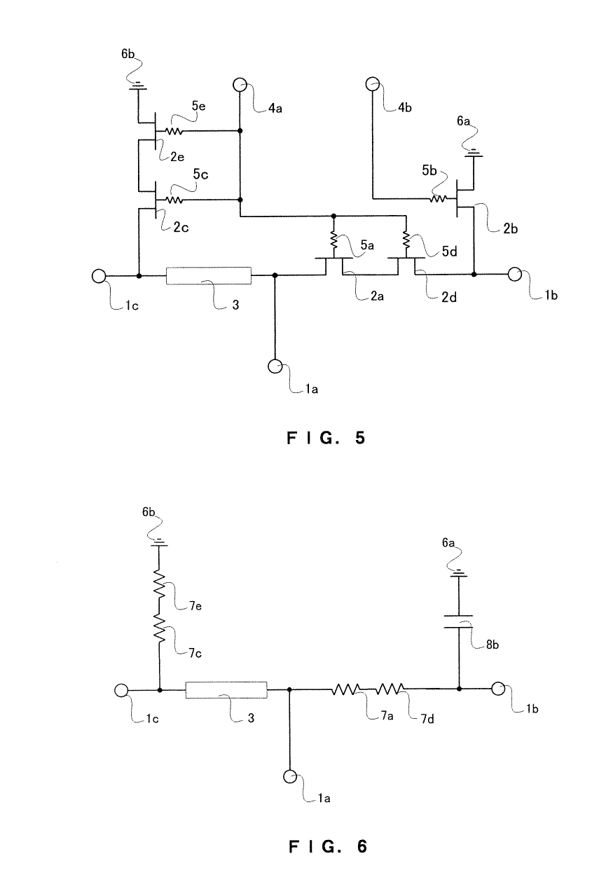

FIG. 5 is a diagram showing a configuration of a high-frequency switch according to a second embodiment of the present invention. The high-frequency switch includes a first input/output terminal 1a, a second input/output terminal 1b, a third input/output terminal 1c, first FETs 2a and 2d cascade-connected with each other, a second FET 2b, third FETs 2c and 2e cascade-connected with each other, a high-frequency line 3, a first control signal terminal 4a, a second control signal terminal 4b, a first resistor 5a, a second resistor 5b, a third resistor 5c, a fourth resistor 5d, a fifth resistor 5e, a first ground 6a, and a second ground 6b.

Next, an operation of the high-frequency switch according to the second embodiment of the present invention will be described.

FIG. 6 is an equivalent circuit in a case where the first FETs 2a and 2d cascade-connected with each other and the third FETs 2c and 2e cascade-connected with each other are turned on and the second FET 2b is turned off. In FIG. 6, reference symbols 7a and 7d denote on-resistances of the first FETs 2a and 2d cascade-connected with each other; 7c and 7e, on-resistances of the third FETs 2c and 2e cascade-connected with each other; and 8b, an off-capacitance of the second FET 2b. In this case, a state between the first input/output terminal 1a and the second input/output terminal 1b becomes a transmission state, and a state between the first input/output terminal 1a and the third input/output terminal 1c becomes an isolation state.

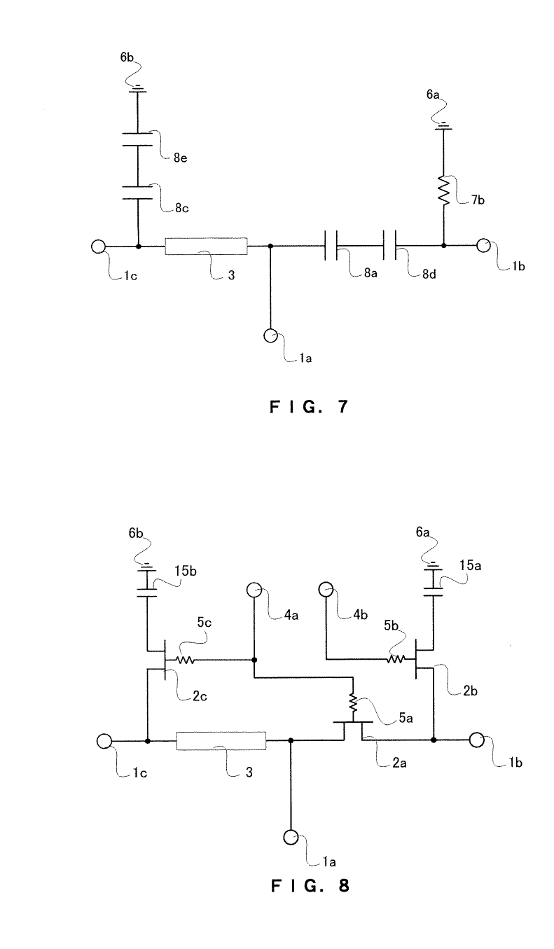

FIG. 7 is an equivalent circuit in a case where the first FETs 2a and 2d cascade-connected with each other and the third FETs 2c and 2e cascade-connected with each other are turned off and the second FET 2b is turned on. Reference symbols 8a and 8d denote off-capacitances of the first FETs 2a and 2d cascade-connected with each other; 8c and 8e, off-capacitances of the third FETs 2c and 2e cascade-connected with each other; and 7b, an on-resistance of the second FET 2b. In this case, a state between the first input/output terminal 1a and the second input/output terminal 1b becomes the isolation state, and a state between the first input/output terminal 1a and the third input/output terminal 1c becomes the transmission state.

According to the second embodiment of the present invention, in a case where the high power handling capability is required when the state between the first input/output terminal 1a and the second input/output terminal 1b is set to the transmission state, there exists no FET through which a large current flows. As a result, there is no need to use an FET having a large gate width, which is effective in reducing the loss of the high-frequency switch. In addition, while a high voltage is applied to each of the first FETs and the third FETs, because a plurality of FETs are cascade-connected with each other, the voltage is distributed, thereby making it possible to reduce the voltage applied to each FET. In the second embodiment, the case where the number of cascade-connections is two has been described. Alternatively, by increasing the number of connections, it is possible to increase the effect of reducing the voltage due to the distribution of the voltage.

### Third Embodiment

FIG. 8 is a diagram showing a configuration of a high-frequency switch according to a third embodiment of the present invention. Series capacitors 15a and 15b are respectively provided between a first ground 6a and a second FET 2b and between the second ground 6b and a third FET 2c.

According to the third embodiment of the present invention, parasitic inductance between the switching elements and the grounds, that is, between the first ground 6a and the second FET 2b and between the second ground 6b and the third FET 2c, and the series capacitors 15a and 15b resonate in series with each other. As a result, the parasitic inductance can be removed, which is effective in reducing the loss of the high-frequency switch and increasing the isolation property.

### Fourth Embodiment

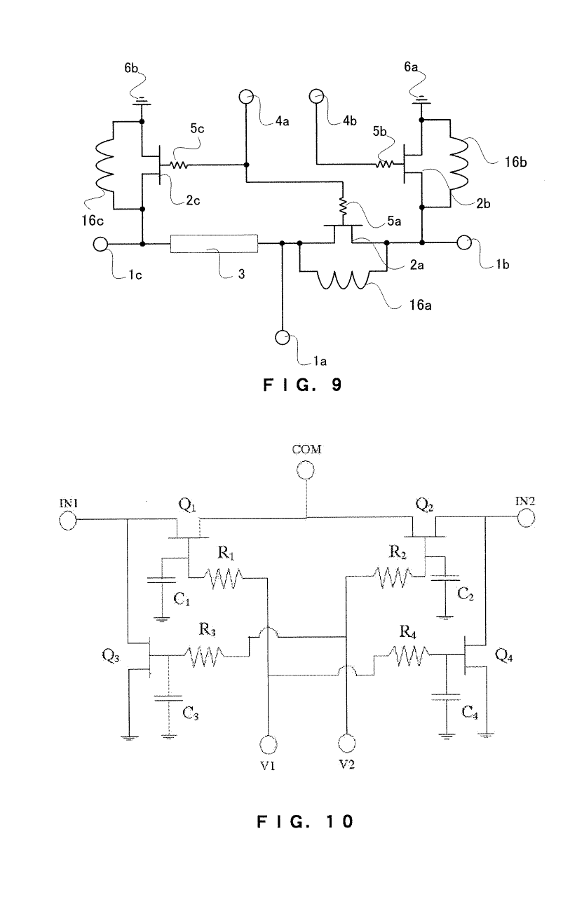

FIG. 9 is a diagram showing a configuration of a high-frequency switch according to a fourth embodiment of the present invention. Parallel inductors 16a, 16b, and 16c are connected in parallel with a first FET 2a, a second FET 2b, and a third FET 2c, respectively.

According to the fourth embodiment of the present invention, the off-capacitance provided by the switching element resonates in parallel with the parallel inductors connected in parallel with the switching elements. As a result, it is possible to increase the isolation property at the time when the switching element is turned off, which is effective in reducing the loss of the high-frequency switch and increasing the isolation property.

Further, in each embodiment, the case where the FETs are each used as a switching element has been described. Alternatively, a PIN diode, a varactor diode, or an MEMS switch may be used as the switching element.

Also in the second to fourth embodiments, in the same manner as in the first embodiment, a high-frequency line having a large occupation area is formed on a dielectric substrate produced at a low cost, and components other than the high-frequency line are formed on a semiconductor substrate. The high-frequency line formed on the dielectric substrate, and a first input/output terminal and a third input/output terminal that are formed on the semiconductor substrate are connected to each other via wires. With this configuration, an area for the semiconductor substrate can be reduced, which is effective in reducing costs of the high-frequency switch.

Further, also in the second to fourth embodiments, in the same manner as in the first embodiment, when the electric length of the high-frequency line is set to ¼ wavelength of the operating frequency, and the relationship among the impedance Z1a of the first input/output terminal 1a, the impedance Z1c of the third input/output terminal 1c, and the impedance Z3 of the high-frequency line 3 is set to satisfy the following formula

Z1a=Z1c=Z3

or

Z1c=2×Z1a,

Z3=v2×Z1a,

the impedance matching property of the high-frequency circuit can be obtained, which is effective in increasing the power handling capability and reducing the loss.

According to the present invention, a high-frequency switch with a low loss and high power handling capability can be achieved. Therefore, in a case where the present invention is applied to an antenna of radio communication equipment, the antenna can be used with a low loss and large power.

What is claimed is:

1. A high-frequency switch, comprising:
a first input/output terminal;
a first switching element having one end connected to the first input/output terminal;
a second switching element having one end connected to the other end of the first switching element;
a first ground connected to the other end of the second switching element;
a second input/output terminal connected to the other end of the first switching element;
a high-frequency line having one end connected to the first input/output terminal;
a third switching element having one end connected to the other end of the high-frequency line;
a second ground connected to the other end of the third switching element; and
a third input/output terminal connected to the other end of the high-frequency line.

2. A high-frequency switch according to claim 1, wherein:
the first switching element, the second switching element, and the third switching element each comprise a field effect transistor; and
the field effect transistors each have a saturation current set to satisfy the following relationship:
(the third switching element)=(the first switching element)=(the second switching element).

3. A high-frequency switch according to claim 1, wherein the first switching element and the third switching element each have a plurality of switching elements cascade-connected with each other.

4. A high-frequency switch according to any one of claims 1 to 3, wherein at least one of the first ground and the second ground comprises a series capacitor.

5. A high-frequency switch according to any one of claims 1 to 3, wherein at least one of the first switching element, the second switching element, and the third switching element comprises a parallel inductor.

6. A high-frequency switch according to any one of claims 1 to 5, wherein:
the high-frequency line has an electric length set to ¼ wavelength of an operating frequency; and
impedance values are set such that impedance of the first input/output terminal, impedance of the third input/output terminal, and impedance of the high-frequency line are set to be equal to each other.

7. A high-frequency switch according to any one of claims 1 to 5, wherein:
the high-frequency line has an electric length set to ¼ wavelength of an operating frequency; and
impedance values are set such that impedance of the third input/output terminal is twice as large as impedance of the first input/output terminal, and impedance of the high-frequency line is v2 times as large as the impedance of the first input/output terminal.

8. A high-frequency switch according to any one of claims 1 to 7, wherein:
the high-frequency line is formed on a dielectric substrate; and
components other than the high-frequency line are formed on a semiconductor substrate.
